(19) United States
(12) Patent Application Publication
(10) Pub. No.: US 2009/0199580 A1
(43) Pub. Date: Aug. 13, 2009

(54) AIR CONDITIONING SYSTEM CONTROL

(75) Inventor: GEOFF SEAN LYON, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: COOLIT SYSTEMS INC., Calgary (CA)

(21) Appl. No.: 12/368,205

(22) Filed: Feb. 9, 2009

Related U.S. Application Data
(60) Provisional application No. 61/027,185, filed on Feb. 8, 2008.

(51) Int. Cl. G05D 23/00

(52) U.S. Cl. 62/157; 700/299

(57) ABSTRACT

A cooling system for cooling a room containing a plurality of computer devices is provided. The cooling system has a number of cooling supplies and at least one temperature sensor. Using the at least one temperature sensor and altering the cooling supplied to the room by the cooling supplies, the affect of each cooling supply on the temperature of the room can be approximated and used for the operation of the cooling system.

The present invention relates to system and methods for controlling the temperature of rooms containing computer devices, such as data centers, and more specifically to systems and methods for obtaining measurements of conditions in the room and determining the contribution of various cooling effects.

### BACKGROUND OF THE INVENTION

Computer systems and electronics are sensitive to environmental temperatures. At the same time, computer systems and electronics can produce significant amounts of thermal energy. As such, rooms that accommodate large numbers of computer servers, computers or other electronics requiring air conditioning, such as data centers, require sophisticated cooling systems to keep the temperature in the room within the devices operating range. Such air conditioning systems, called computer room air conditioning systems (CRACS), generally include a number of air conditioning inlets to the room.

To cool these rooms, it is common to introduce cooling air flows at a relatively high volume from all inlets. In this way, the entire room is either over cooled or the room is cooled to satisfy the requirements of the hottest devices. However, this practice tends to over cool many of the devices. There are energy usage concerns with such an approach to computer room air conditioning.

### SUMMARY OF THE INVENTION

In a first aspect, a method for determining the effect of a plurality of cooling supplies on temperatures in a room containing a plurality of computer devices and at least one temperature sensor is provided. The method comprises: running all of the cooling supplies to provide a first level of cooling and then obtaining a temperature measurement using the at least one temperature sensor; for each cooling supply, altering the cooling provided by the cooling supply and after a selected period of time obtaining a temperature measurement using the at least one temperature sensor; and using the temperature measurements to determine contribution factors, each contribution factor indicating the effect of one of the plurality of cooling supplies at the location of one of the plurality of temperature sensors.

In a further aspect, a cooling system for cooling a room containing a number of computer devices is provided. The system comprises: a plurality of temperature sensors installed in the room; two or more cooling supplies, each cooling supply operative to provide cooling to at least a portion of the room; and a central computer operative to receive temperature measurements measured by the plurality of temperature sensors,

In a further aspect, a computer readable memory for access by an application program being executed on a data processing system is provided. The computer readable memory comprising a data structure stored in said memory. The data structure including information used by said application program and including a plurality of contribution factors, each contribution factor associated with a temperature sensor located in a room and a cooling supply operable to provide cooling to the room, the contribution factor indicating the effect of the associated cooling supply on the temperature in the room where the associated temperature sensor is located.

In a further aspect, a computer for controlling the operation of a cooling system for cooling a room containing a plurality of devices is provided. The computer comprises: an input device operative to receive temperature measurements from a plurality of temperature sensors; an output device operative to control the operation of a plurality of cooling supplies, each cooling supply operative to provide cooling to at least a portion of the room; at least one memory containing program instructions and a plurality of contribution factors, each contribution factor associated with one of the cooling supplies and one of the temperature sensors, the contribution factor indicating how the associated cooling supply effects the temperature in the room at the location of the associated temperature sensor; at least one processing unit operably connected to the input device, the output device and the at least one memory. The at least one processing unit, in response to the program instructions, operative to: in response to receiving a temperature measurement outside a temperature threshold, from at least one of the temperature sensors, obtain the contribution factors associated with the at least one temperature sensor providing the termperature measurement outside the temperature threshold; select at least one of the cooling supplies based on the obtained contributions factors; and control the operation of the at least one selected cooling supply to bring the temperatures to within the temperature thresholds.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic, plan view of a room being cooled by a cooling system;

FIG. 2 is a schematic plan view of an further aspect of a room being cooled by a cooling system;

FIG. 3 is a schematic illustration of a central computer;

FIG. 4 is a schematic illustration of a rack containing a number of temperature sensors;

FIG. 5 is a flowchart illustrating a method of determining how a number of cooling supplies affect temperatures of a room;

FIG. 6 is a data structure; and

FIG. 7 is a flowchart illustrating a method of controller a cooling system.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

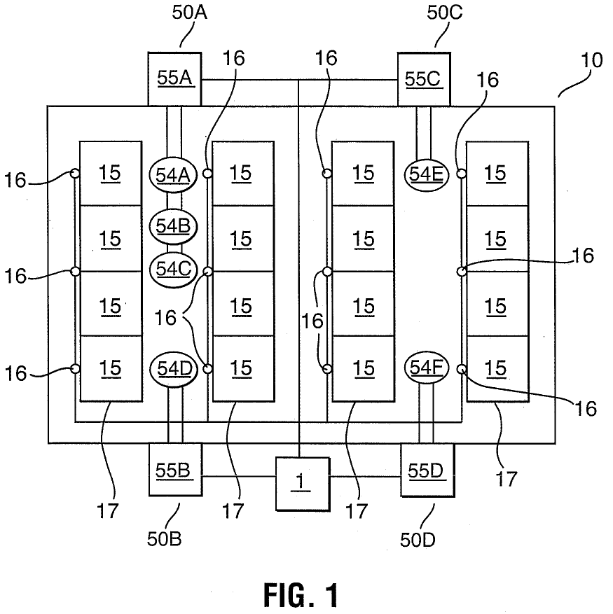

FIG. 1 illustrates a server room 10 that is cooled by a cooling system 1 in a schematic plan view, such as a data center. Server room 10 is representative of rooms housing electronics such as servers, storage, computers, etc. that generate considerable heat and are sensitive to heat such that the room 10 must be air conditioned.

Room 10, for example, may have a plurality of racks 15 with each rack 15 having a plurality of devices (not shown), such as servers or other devices that generate heat as a byproduct of their operation. Additionally, each device in the room 10 will not necessarily generate the same amount of heat. Often, different devices in the room 10 will generate different amounts of heat with some devices generating significantly more heat than other devices. The racks 15 can be distributed through the room 10 to allow access to the devices in the racks 15 and provide room between the racks 15 and devices to allow flows of cooled air to pass between the racks 15. Typically, the racks 15 can be arranged in one or more rows 17 within the room 10, allowing a person to move in between the racks 15 and gain access to the one or more devices contained in each rack 15. A person skilled in the art will appreciate that more or less racks 15 and rows 17 than the number shown in FIG. 1 could be used in room 10.

The cooling system 1 can be used to cool the room 10 and compensate for the heat generated by the devices in the room 10. In one aspect, the cooling system 1 can have a plurality of cooling supplies 50A, 50B, 50C, 50D operative to supply cooled air to the room 10. In one aspect, as illustrated in FIG. 1, each of the cooling supplies 50A, 50B, 50C, 50D could comprise an air conditioning unit and one or more inlets operably connected to one of the air conditioning units. In this manner, cooled air supplied to the room 10 by each of the cooling supplies 50A, 50B, 50C, 50D can be varied independently from each of the other cooling supplies 50A, 50B, 50C, 50D. For example, in FIG. 1 the first cooling supply 50A includes a first air conditioning unit 55A and inlets 54A, 54B, 54C, a second cooling supply 50B includes a second air conditioning unit 55B and inlet 54D, a third cooling supply 50C includes a third air conditioning unit 55C and inlet 54E, and a fourth cooling supply 50D includes a fourth air conditioning unit 55D and inlet 54F. Although FIG. 1 illustrates four cooling supplies 50A, 50B, 50C, 50D, a person skilled in the art will appreciate that more or less cooling supplies could be used to supply cooled air to the room 10.

The plurality of inlets 54A, 54B, 54C, 54D, 54E, 54F can be provided leading into the room 10. These inlets 54A, 54B, 54C, 54D, 54E, 54F can be mounted in the ceiling, walls or floors of the room 10. These inlets 54A, 54B, 54C, 54D, 54E, 54F can be operably connected to the air conditioning units 55A, 55B, 55C, 55D so that each air conditioning unit 55A, 55B, 55C, 55D cools air and then routes the cooled air into the room 10 through the corresponding inlet(s) 54A, 54B, 54C, 54D, 54E, 54F, that is operably connected to the air conditioning unit 55A, 55B, 55C, 55D. As shown in FIG. 1, in some aspect more than one inlet 54A, 54B, 54C can be connected to a single air conditioning unit 55A, so that a flow of air that has been cooled by the air conditioning unit 55A can be routed into the room 10 through any of inlets 54A, 54B, 54C.

The inlets 54A, 54B, 54C, 54D, 54E, 54F can be spaced around the room 10 so that each air inlet 54A, 54B, 54C, 54D, 54E, 54F tends to be directed at a specific portion of the room 10.

Each cooling supply 50A, 50B, 50C, 50D can be independently controllable so that a flow of cooled air supplied to the room 10 by each cooling supply 50A, 50B, 50C, 50D is separately controllable. In this manner, each cooling supply 50A, 50B, 50C, 50D can have the amount of cooling being supplied to the room 10 varied independently of the other cooling supplies 50A, 50B, 50C, 50D by controlling the operation of the different air conditioning units 55A, 55B, 55C, 55D.

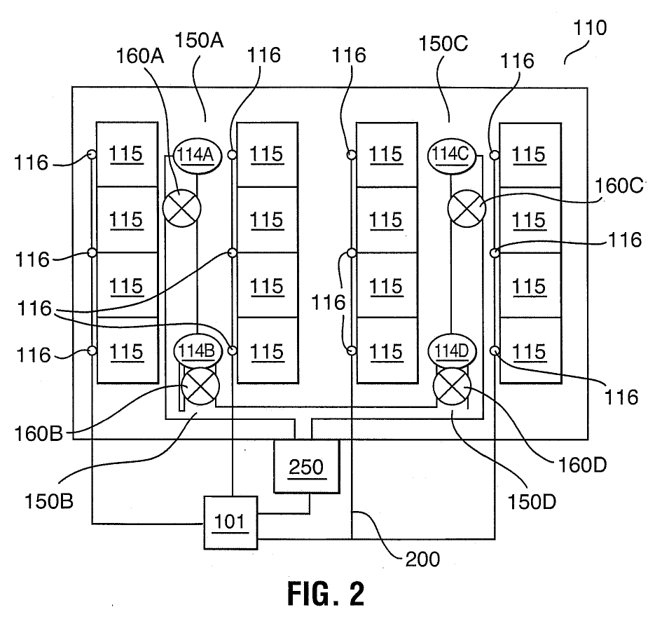

FIG. 2 illustrates a room 110 in another aspect that contains a plurality of rack 115 holding computer devices, which can have a cooling system 200 having cooling supplies 150A, 150B, 150C, 150D. Cooling supplies 150A, 150B, 150C, 150D can be provided and wherein each cooling supply 150A, 150B, 150C, 150D can be supplied with cooled air from a single central air conditioning unit 155. Each cooling supply 150A, 150B, 150C, 150D can have an inlet 114A, 114B, 114C, 114D operably connected to the central air conditioning unit 250. Damper 160A, 160B, 160C, 160D can be provided between each inlet 114A, 114B, 114C, 114D and the central air condition unit 155 allowing the cooling provided to the room 110 by each inlet 114A, 114B, 114C, 114D to be varied by operation of the respective damper 160A, 160B, 160C, 160D. In this manner each cooling supply 150A, 150B, 150C, 150D can be varied by controlling the amount of cooled air from the central air conditioning unit 250 that is passing out of the air inlet 114A, 114B, 114C, 114D associated with the cooling supply 150A, 150B, 150C, 150D.

A plurality of temperature sensors 116 can be provided throughout the room 110, with the temperatures sensors 116 operative to take temperature measurements and communicate them to a central computer 101 in one aspect. In an aspect, the central computer 101 may be operably connected to the cooling supplies 150A, 150B, 150C, 150D so that the central computer 101 can control the operation of the cooling supplies 150A, 150B, 150C, 150D.

Although FIG. 2 illustrates four (4) cooling supplies 150A, 150B, 150C, 150D a person skilled in the art will appreciate that more or fewer cooling supplies could be used.

Referring again to FIG. 1, a plurality of temperature sensors 16 can be provided throughout the room 10 (or a plurality of temperature sensors 116 can be provided throughout room 110 shown in FIG. 2). Each temperature sensor 16 can be capable of measuring the temperature of the air in the room 10 at the location where the temperature sensor 16 is located.

In one aspect, the temperature sensors 16 can be operatively connected via a communication link to a central computer 1 for ease of monitoring. The temperature sensors 16 may be linked to a central computer 1 in order to facilitate collecting information once or a plurality of times from the temperature sensors 16 and possibly to provide for automated collection and analysis. Each temperature sensor 16 can be operably connected to a central computer 1 so that temperature measurements taken by the temperature sensors 16 can be communicated to the central computer 1.

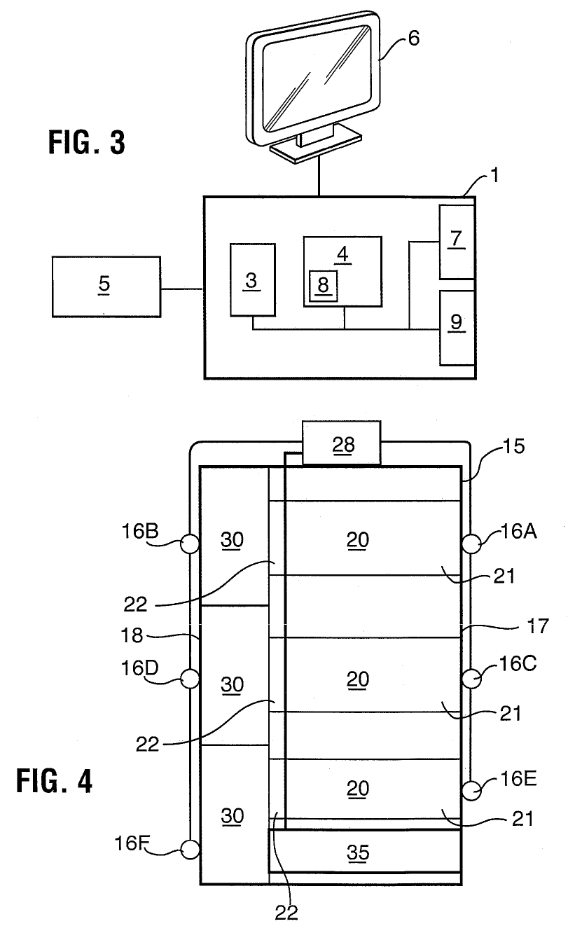

FIG. 3 illustrates a central computer 1 suitable for supporting the operation of methods in accordance with the present invention. Computer 1 can comprise: at least one processing unit 3; a memory storage device 4; at least one input device 5; a display device 6 and a program module 8. The processing unit 3 can be any processor that is typically known in the art with the capacity to run the program and is operatively coupled to the memory storage device 4 through a system bus. In some circumstances the computer 1 may contain more than one processing unit 3. The memory storage device 4 is operative to store data and can be any storage device that is known in the art, such as a local hard-disk, etc. and can include local memory employed during actual execution of the program code, bulk storage, and cache memories for providing temporary storage. Additionally, the memory storage device 4 can be an external computer readable memory, such as a database, that is external to the data processing system 1 but operatively coupled to the computer 1. The input device 5 can be any suitable device suitable for inputting data into the computer 1, such as a keyboard, mouse or data port such as a network connection and is operatively coupled to the processing unit 3 and operative to allow the processing unit 3 to receive information from the input device 5. The display device 6 can be a CRT, LCD monitor, etc. operatively coupled to the computer 1 and operative to display information. The display device 6 could be a stand-alone screen or if the computer 1 is a mobile device, the display device 6 could be integrated into a casing containing the processing unit 3 and the memory storage device 4. Program instructions 8 can be stored in the memory storage device 4 and operative to provide instructions to processing unit 3 and the processing unit 3 is responsive to the instructions from the program instructions 8.

In one aspect, the computer 1 may have an input device 7, such as an I/O digital/analog data port, serial interface, network connection, etc., to operatively connect the computer 1 to the temperature sensors 16 and allow temperature measurements taken by the temperature sensors 16 to be communicated to the computer 1. The input device 7 could allow the computer 1 to be directly wired to the temperature sensors 16 or allow wireless communication between the computer 1 and the temperature sensors 16. An output device 9, such as an I/O digital analog data port, serial interface, network connection, etc. could be provided to allow the computer 1 to communicate with the cooling supplies 50A, 50B, 50C, 50D and control the operation of the cooling supplies 50A, 50B, 50C, 50D. The output device 9 could provide a wired or wireless communication link with the cooling supplies 50A, 50B, 50C, 50D.

Although other internal components of the computer 1 are not illustrated, it will be understood by those of ordinary skill in the art that only the components of the computer 1 necessary for an understanding of the present invention are illustrated and that many more components and interconnections between them are well known and can be used.

The temperature sensors 16 may be mounted in the room in various ways. In one aspect, the temperature sensors 16 may be simply installed at various locations throughout the room 10, possibly at relatively regular spaced intervals. The temperature sensors 16 can be positioned so that they are distributed throughout the room 10, with at least one of the temperature sensors 16 being positioned generally centrally in the room 10. However, in another aspect, the temperatures sensors 16 can be installed on at least some of the racks 15 to be capable of measuring the temperature of the air at the different racks 15. In another aspect, temperature sensors 16 can be installed on a major portion of the racks 15 so that the temperature of the air located at each rack 15 can be monitored by the central computer 1. In another aspect, temperature sensors 16 can be mounted to each rack 15 in the room 10.

As will be appreciated, a greater number of temperature sensors 16 will provide the central computer 1 with a more detailed analysis of the temperature conditions through the room 10.

In one embodiment, the temperature sensors 16 are linked to the central computer 1 and the central computer 1 is also operatively connected to the cooling supplies 50A, 50B, 50C, 50D to provide for control of the air conditioning units/volume and temperature of flows through inlets and may provide for control of components in the room (i.e. control of the rack cooling systems, control of one or more devices in one or more racks, etc.).

Referring to FIG. 4, in a further aspect, each rack 15 can have a number of temperature sensors 16A, 16B, 16C, 16D, 16E, 16F installed relative to the rack 15 with the temperature sensors 16A, 16B, 16C, 16D, 16E, 16F installed at different heights. In this manner, the temperature of the air surrounding the rack 15 can be measured at various heights. Although rack 15 is shown in FIG. 4 a person skilled in the art will appreciate that racks 115 shown in FIG. 2 could also be configured in this manner. The temperature sensors 16A, 16B, 16C, 16D, 16E, 16F may be positioned on the racks 15 in various locations, for example on an exterior or interior position of a rack 15 or on a device 20 within the rack 15. In one embodiment, temperature sensors 16A, 16C, 16E may be positioned in a cooling air intake of a rack 15, such as a fan intake. These temperature sensors 16A, 16C, 16E may be useful to assist with an optimization of room cooling and may be used to detect the thermal condition of the air intake for rack 15 or device 20 and so may have a plurality of purposes. In particular, reference may be made to applicant's corresponding U.S. patent application Ser. No. 11/969,766 wherein a system for predicting the cooling requirements of a rack or device is described.

In one aspect, the temperature sensors 16A, 16B, 16C, 16D, 16E, 16F are installed in the rack 15 and associated in inlet/outlet pairs, with inlet temperature sensors 16A, 16C, 16E of each inlet/outlet pair provided on a first side of the rack 15. The inlet temperature sensors 16A, 16C, 16E can be placed in an intake path of air entering the rack 15 on a first side 17 of the rack 15 to measure the temperature of air entering the rack 15 before it passes by the devices 20 in the rack 15. These inlet temperature sensors 16A, 16C, 16E can be positioned proximate to inlet ends 21 of the devices 20. The outlet temperature sensors 16B, 16D, 16F of the inlet/outlet pairs can be mounted on a second side 18 of the rack 15, proximate discharge ends 22 of the devices 20, to measure the temperature of air that has passed through or by the devices 20 in the rack 15. For example, in FIG. 4, temperature sensors 16A and 16B may be an associated inlet/outlet pair, temperature sensors 16C and 16D may be an associated inlet/outlet pair and temperature sensors 16E and 16F may be an associated inlet/outlet pair. In this manner, a temperature differential measured between one the associated inlet/outlet pairs can be used to identify a device 20 in the rack 15 that is generating significant heat. For example, if the temperature measurements taken between the inlet temperature sensor 16A and the outlet temperature sensor 16B show that the temperature being measured by the outlet temperature sensor 16B is much greater than the temperature of the air entering the rack 15 where temperature sensor 16A is located, this could indicate that the device 20 positioned between the inlet temperature sensor 16A and outlet temperature sensor 16B is generating a significant amount of heat. This information could then be used to supply more cool air to the rack 15, to provide spot cooling to the device 20 generating the heat, move the device 20 to a cooler part of the room 10, etc.

Each rack 15 can be provided with one or more fans 30 so that ambient air from intake ends 21 of the devices 20 is drawn over and/or through the devices 20, past discharge ends 22 of the devices 20 and into the fans 30 to cool the electric components of the devices 20. The fans 30 are shown positioned proximate to the discharge ends 22 of the devices 20 to draw air through or over the devices 20, however, a person skilled in the art will appreciate that the fans 30 could be positioned proximate to the intake ends 21 of the device 20, be incorporated inside the devices 20, etc.

A control system 28 can be provided with each rack 15, with the control device 28 being operatively connected, either directly, wirelessly, through other components, etc. to the temperature sensors 16A, 16B, 16C, 16D, 16E, 16F positioned on the rack 15 so that the control system 28 can obtain temperature measurements recorded by the temperature sensors 16A, 16B, 16C, 16D, 16E, 16F.

The control system 28 can also be operatively connected to a power supply 35 that supplies power to the different devices 20 in the rack 15. The control system 28 can be operatively connected to the power supply 35 such that the control device 28 can obtain information from the power supply 35 regarding how much power is being supplied to the device 20 in the rack 15 by the power supply 35. The power supply 35 may be directed connected to the control system 28 or wireless connected to the control system 28 to allow the power supply 35 to communicate its status to the control system 28. In one aspect, the communication may be as close to real time as possible so that the control system 28 is aware of the status of the power supply 35 as the status of the power supply 35 is changing.

The control system 128 can also be operatively connected to the fan 30, so that the control system 128 can control the operation of the fan 30, such as by controlling the operating speed of the fan 30, turning the fan 30 on or off, etc.

Referring to FIGS. 1 and 4, the control system 28 of each rack 15 can be operatively connected to the central computer 1 so that all the information obtained by the control systems 28 on the various racks 15 can be communicated to the central computer 1. This information could include temperature measurements from the temperature sensors 16A, 16B, 16C, 16D, 16E, 16F mounted on the rack 15, power draw by the power supply 35, information from the devices 20 in the rack 15, operation of the fans 30, etc. This information can be stored on a memory of the control system 28 and/or communicated to the central computer 1. The information from each control system 28 can include an identifier indicating which control system 28 provided the information to the central computer 1, allowing the central computer 1 to determine which control system 28 obtained the information and even which rack 15 the information came from. For example, in this manner the central computer 1 can determine from a temperature measurement taken by a temperature sensor 15 in the room 10, which rack 15 in the room 10 the temperature sensor 16 is installed on and therefore what the temperature is at that specific rack 15.

The control system 28 can operate as that disclosed in applicant's corresponding US application U.S. patent application Ser. No. 11/969,766. Control system 28 can monitor temperature information and also power from power supply 30 such that system can also operate in a predictive cooling system.

Referring again to FIG. 1, the temperature information obtained can be used to generate reports and logged information for room managers and, for example, to verify energy efficient operations or for system diagnostics. Ongoing temperature sensing can be used to generate substantially real time feedback and, for example, visual representations of room cooling.

With the information collected from the temperature sensors 16 provided throughout the room 10 (or temperature sensors 116 throughout room 110), the information can be used to provide a visualization of the temperatures throughout the room 10. If the locations or approximate locations of the various temperatures sensors 16 are known to the central computer 1 (or if the temperature sensors 16 are installed on racks, the approximate locations of the racks 15 and which temperature sensors 16 installed on which racks 15 are known), the central computer 1 can provide a visualization of the temperatures throughout the room 10. In this manner, an operator can easily see areas in the room 10 that are hotter or cooler relative to other areas. If a number of temperature sensors 16A, 16B, 16C, 16D, 16E, 16F are installed at different heights on a rack 15, as shown in FIG. 4, the central computer 1 can provide a three dimensional visualization of the temperatures in the room 10 at various heights.

With the collected temperature information, locations in the room 10 (or room 110) that are either warmer or cooler than desired can be determined. Rather than attempting to predictively model where warm spots or cools spots in the room 10 may be located, the present system allows measurements to be taken throughout the room 10 and actual existing warm spots and cool spots determined based on the actual operation of the cooling system 100. In this manner, using the temperature measurement collected throughout the room 10 or room 110, the cooling supplies 50A, 50B, 50C, 50D or cooling supplies 150A, 150B, 150C, 150D can be adjusted until the desired temperatures are reached, additional cooling supplies can be provided, spot cooling provided, devices located in the room moved around, etc.

In one aspect, using the inlet/outlet pair of temperature sensors positioned on the rack 15 as shown in FIG. 4, by determining a temperature differential between the inlet temperature sensors 16A, 16C, 16E and the associated outlet temperature sensors 16B, 16D, 16F, devices 20 in the room 10 that are running hotter than expected can be located and dealt with, such as by providing more cooling to the devices in the room 10 using one or more of the cooling supplies 50A, 50B, 50C, 50D, adding spot cooling to the room 10 at the location of the devices, etc.

In a further aspect, not only can the information obtained from the system be useful to allow visualization of the room 10 (or room 110), provide insight into the temperature of air throughout the room 10 (or room 110), allow problems in the cooling to be diagnosed and addressed, etc., the system can be used to approximate how much effect each cooling supply 150A, 150B, 150C, 150D has on the temperatures being measured throughout the room 10. Rather than trying to predictively model the effects of the various cooling supplies 50A, 50B, 50C, 50D on the temperature of the air throughout the room 10, (or the effects of the various cooling supplies 150A, 150B, 150C, 150D on the room 110) a configuration method can be performed allowing the effect of each cooling supply 50A, 50B, 50C, 50D to be determined at various locations throughout the room 10. In this manner, how the operation of the various cooling supplies 50A, 50B, 50C, 50D will affect the temperature of the air throughout the room 10 can be determined and used to control the operation of the cooling system 100.

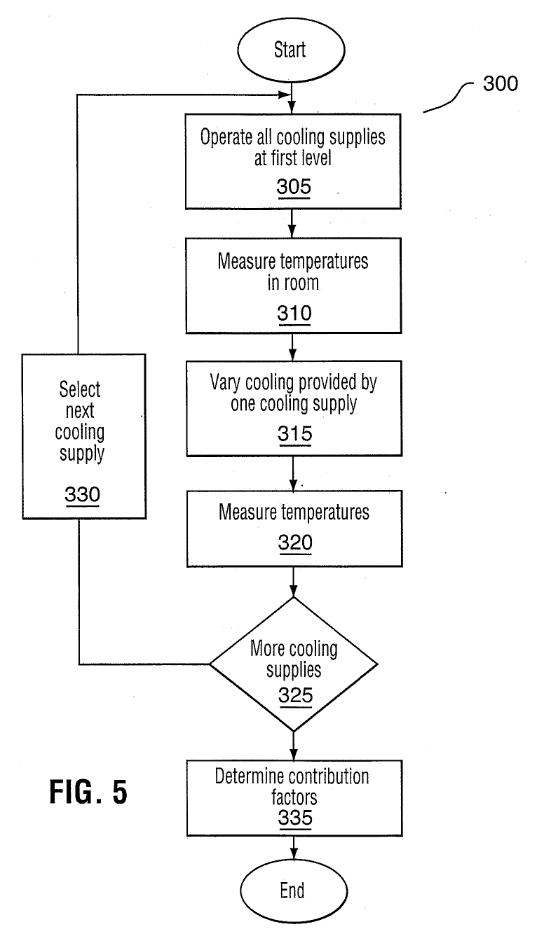

FIG. 5 is a flow chart illustrating a method 300 that can be performed for determining the effect of a cooling system on a room, such as the cooling system 100 and the room 10 shown in FIG. 1 or the cooling system 200 and the room 110 shown in FIG. 2. The method 300 starts and all of the cooling supplies 50A, 50B, 50C, 50D are set to a first level of operation to deliver a selected amount of cooled air to the room 10 at step 305. In one aspect, each of the cooling supplies 50A, 50B, 50C, 50D can be operated to provide the maximum amount of cooling it can deliver for this first level. For example, if each cooling supply 50A, 50B, 50C, 50D comprises one of the air conditioning units 55A, 55B, 55C, 55D and the air inlets 54A, 54B, 54C, 54D, 54E, 54F operatively connected to the air conditioning unit 55A, 55B, 55C, 55D , as shown in FIG. 1, all of the air conditioning units 55A, 55B, 55C, 55D can be set to be driven at substantially full power (i.e. full fan power and/or full cooling power) with the air inlets 54A, 54B, 54C, 54D, 54E, 54F fully open, to deliver a maximum cooling load to the room 10. However, the air conditioning units 55A, 55B, 55C, 55D could also be driven at a first level that is below their maximum operating output such as at a level of operation that might emulate more regular operation of the air conditioning units 55A, 55B, 55C, 55D.

At step 305, all of the cooling supply 50A, 50B, 50C, 50D are operated at the first level for a first period of time. In one aspect, this first period of time could be the length of time before temperature measurements taken from the room 10 indicated that the room 10 has reached a stabilization of temperature. By stabilization of temperatures, it is intended that the temperature begins to fluctuate around a temperature rather than changing in only one direction (i.e. increasing or decreasing). Alternatively, the cooled air can be supplied for a set period of time, which may vary, but is selected so that the period of time is sufficiently long to provide adequate time for stabilization to occur. For example, a selected period may be at least 30 minutes and may be one day or more. The period of time will be based on various factors, such as cooling capacity of the overall cooling system 100, size of the room 10, etc. Of course, since temperatures may be monitored, a condition may be avoided where the temperature in any region of the room 10 exceeds that temperature above which operation of devices 20 in the room 10 may be compromised.

After the first period of time, the method 300 will move onto step 310 and temperatures in the room 10 are measured. Typically, the temperature sensors 16 are used to take temperature readings in the room 10, so that each temperature sensor 16 will measure the temperature of the room 10 at each point that one of the temperature sensors 16 is located. The temperature measurements taken by the temperature sensors 16 at step 310 can be communicated to the central computer 1.

After temperature reading have been taken at step 310, the method 300 continues to step 315 where the cooling provided by one of the cooling supplies 50A, 50B, 50C, 50D is varied for a second period of time. The cooling provided to the room 10 by the selected cooling supplies 50A, 50B, 50C, 50D can be varied so that it provides less cooling than at step 305, even to the point of providing no cooling to the room 10 (i.e. shutting off the selected cooling supply 50A, 50B, 50C, 50D). For example, the first cooling supply 50A could be shut off while the other cooling supplies 50B, 50C, 50D continue to provide the same amount of cooling that they did in step 305.

At step 315, the output of the selected cooling supply 50A, 50B, 50C, 50D is varied for a second period of time. The second time period could be long enough for the temperature in the room 10 to stabilize or simply a selected period of time that is sufficiently long for the change in the amount of cooling provided by the selected cooling supplies 50A, 50B, 50C, 50D to noticeably affect the temperature of the air in the room 10.

After step 315 is performed for the second time period, the method 300 moves to step 320 and temperature measurements can be taken in the room 10 to determine the affect of varying the cooling supplied by the selected cooling supply 50A, 50B, 50C, 50D. Typically, temperature measurements can be taken with each of the temperature sensors 16 positioned throughout the room 10 to determine the temperature of the room 10 at the different locations where the temperature sensors 16 are positioned. After the cooling provided by the selected cooling supplies 50A, 50B, 50C, 50D has been varied for the second time period, measuring the temperature at various locations throughout the room 10 will result in variations in temperature throughout the room 10 to be observed. Some of the temperature sensors 16 in the room 10 may measure an increase in temperature while other temperature sensors 16 will not measure any change. It is also possible that some of the temperature sensors 16 will measure a decrease in temperature even though the total amount of cooled air being supplied to the room 10 has been reduced. This could be due to another more effective cooling flow being now able to move into an area of the room that was previously affected by a flow or air from one of the other cooling supplies 50A, 50B, 50C, 50D being modified.

From the temperature readings obtained using the temperature sensors 16, it will become apparent as to the influence that the varying of the cooling supplied by the selected cooling supplies 50A, 50B, 50C, 50D will have on temperatures in the room 10. Such influence may be defined as the effect zone of the selected cooling supplies 50A, 50B, 50C, 50D as determined by temperature sensors 16. The temperature measurements can be communicated to the central computer 1 where they can then be stored in the memory of the central computer 1.

With the temperature measurements taken at step 320, the method 300 checks if any more of the cooling supplies 50A, 50B, 50C, 50D remain to be varied at step 325. If more cooling supplies 50A, 50B, 50C, 50D remain to be varied, the method 300 can select the next cooling supplies 50A, 50B, 50C, 50D to be varied at step 330. For example, if cooling supply 50A was previously selected, cooling supply 50B might be selected at step 330. Once the next cooling supply 50B is selected at step 330, the method 300 then returns to step 305, running all of the cooling supplies 50A, 50B, 50C, 50D at a constant rate for the first period of time to bring the temperatures of the room 10 back to a baseline temperature. The method 300 can then move to step 310 and temperature measurements can again be taken using the temperature sensors 16.

At step 315 the output of the next selected cooling supply 50A, 50B, 50C, 50D is varied for the second period of time and then temperature measurements are taken at step 320 using the temperature sensors 16.

By varying the flow of each cooling supply 50A, 50B, 50C, 50D and measuring the result changes in temperature throughout the room 10, the changes in the temperature measurements should indicate how altering the flow of cool air from the next selected cooling supply 50A, 50B, 50C, 50D affects the temperature of the room 10 at the locations of the temperature sensors 16.

The method 300 can continue in this manner for the remaining cooling supplies 50A, 50B, 50C, 50D, altering the flow of cooled air supplied by each of the cooling supplies 50A, 50B, 50C, 50D in turn until all of the cooling supplies 50A, 50B, 50C, 50D have been varied, and approximating the influence zone of each cooling supply 50A, 50B, 50C, 50D in turn. Some of the cooling supplies 50A, 50B, 50C, 50D may have a larger influence zone, than others. This may be due to the nature of heat generating devices in the zone, the power (cooling power, fan drive power, etc.) of cooling supply 50A, 50B, 50C, 50D, blockages along and through venting leading to the inlets 54A, 54B, 54C, 54D, 54E, 54F, and other effects or various of the foregoing in various combinations.

When each cooling supply 50A, 50B, 50C, 50D has been varied and the resulting temperature changes measured, the method 300 can move onto step 335 and the effect of each cooling supply 50A, 50B, 50C, 50D in the room 10 can be approximated. Using the temperature information obtained at steps 315 and 325 of the method 300, a set of contribution factors can be determined. Each contribution factor can be used to relate one of the temperature sensors 16 to one of the cooling supplies 50A, 50B, 50C, 50D. A contribution factor can be determined for each temperature sensor 16 in the room 10 relative to each of the cooling supplies 50A, 50B, 50C, 50D, with the contribution factor indicating what effect each cooling supply 50A, 50B, 50C, 50D has on the temperature sensor 16. For example, for temperature sensors 16 that are positioned at or near where the first cooling supply 50A is introduced into the room 10 the contribution factor for those temperature sensors 16 may indicate that the first cooling supply 50A has a relatively large effect on the temperature of the air surrounding those temperatures sensors 16. For temperature sensors 16 positioned in a location in the room 10 far from the first cooling supply 50A, the contribution factor for that temperature sensor 16 relative to the first cooling supply 50A may indicate that the first cooling supply 50A has little or no effect on the temperature of the air at the temperature sensor 16.

For each temperature sensor 16, a contribution factor could be determined based on the temperature differential that was measured at the temperature sensor 16 when the cooling provided by the cooling supply 50A, 50B, 50C, 50D was varied. In one aspect, these contribution factors could be represented as a percentage contribution of each cooling supply 50A, 50B, 50C, 50D to the temperature measured at the temperature sensor 16. For example in a simple example, if the average temperature change achieved by altering of the cooling provided by each cooling supply 50A, 50B, 50C, 50D is determined, such averages can be used to determine an index based on the percent contribution of each inlet.

With the set of contribution factors determined at step 335, the method 300 can end. After the method 300 has finished, the central computer 1 can have determined and stored a step of contribution factors where each contribution factor indicates how much a cooling supply 50A, 50B, 50C, 50D affects the temperature that has been observed at one of the temperature sensors 16.

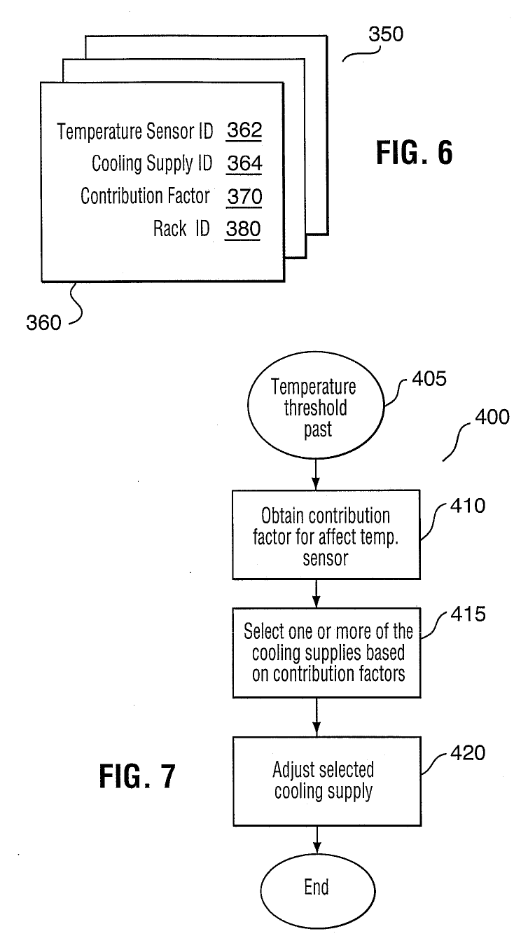

These contribution factors can then be stored in the memory 4 of the central computer 1 or some other memory accessible by the central computer 1. In one aspect, the contribution factors could be stored as a table in the memory 4 of the central computer 1, however, FIG. 6 illustrates a possible data structure 350 for storing the contribution factors. Data structure 350 contains a plurality of records 360. Each record 360may include a temperature sensor identifier field 362, a cooling supply identifier field 364, and a contribution factor field 370. The temperature sensor identifier field 362 can hold a value identifying the temperature sensors 16 that the record is associated with and the cooling supply field 364 can be used to hold a value indicating the cooling supply 50A, 50B, 50C, 50D that the record is associated with. The contribution factor field 370 can be used to hold a value indicating a contribution factor for the temperature sensor 16 indicated in the temperature sensor identifier field 362 relative to the cooling supply 50A, 50B, 50C, 50D indicated in the cooling supply field 364.

In a further aspect, if some or all of the temperature sensors 16 are located on a rack 15, one or more of the records 360 could also contain a rack identifier 380 indicating a rack 15 the temperature sensor that is identified in the temperature sensor identifier 362 of the same record 360 is installed on. In this manner, the Although method 300 was described with reference to the cooling system 100 and the room 10 shown in FIG. 1, a person skilled in the art will appreciate the method 300 could also be used for cooling system 200 shown in FIG. 2 with cooling supplies 50A, 50B, 50C, 50D varied by controlling dampers 160A, 160B, 160C, 160D.

Alternately or in addition, if the room set up is changed, as by installation of new equipment, the foregoing method can be carried out again to verify or selected new cooling power levels for the various inlets/air conditioning units serving in the room.

If it is desired to only determine the effect of one of the modification of cooling power or fan drive apart from the other effect, it may be useful to continue one or the other at substantially full power and modify/alter only one cooling effect at once from a cooling supply 50A, 50B, 50C, 50D. From the temperature readings obtained, it will become apparent as to the influence that the modification in the cooling has on the room 10. Such influence may be defined as the zone of effect as determined by the temperature sensors 16 and can be can be recorded.

Alternatively, the cooling supplies 50A, 50B, 50C, 50D can each be altered by for example fan drives reduced or discontinued, inlet louvers closed fully or partially, and/or cooling power reduced or discontinued, through one inlet, inlet 14A for example, as by cutting power to the air conditioning unit 55A, generating the fan drive and cooled air for the inlet 14A, 14B, 14C, 14D, 14E, 14F.

Alternatively, the contribution factors may be determined by passively monitoring the cooling system 100 over time and determining the contribution factors during the course of normal operation of the cooling system 100. The contribution factors could be determined based on how the temperature measurements change as a result of the operation of the different cooling supplies 50A, 50B, 50C, 50D during normal operation.

Using the contribution factors indicating the effect each cooling supply 50A, 50B, 50C, 50D has on temperatures throughout the room 10, the operation of the cooling supplies 50A, 50B, 50C, 50D can be controlled so that the devices in the room 10 are adequately cooled without over driving any of the cooling supplies 50A, 50B, 50C, 50D and expending unnecessary energy. Using the contribution factors, the effect of each cooling supply 50A, 50B, 50C, 50D at each temperature sensor 16 in the room can be known and the operation of the cooling supplies 50A, 50B, 50C, 50D controlled based on the contribution factors to supply cooling to any specific temperature sensor 16 in the room 10. Rather than simply running the cooling supplies 50A, 50B, 50C, 50D until a desired temperature is achieved at a specific location in the room or trying to select one of the cooling supplies 50A, 50B, 50C, 50D based on attempting to predictively model the effects of the cooling supplies 50A, 50B, 50C, 50D using calculations and assumptions, the contribution factors allow a cooling supply 50A, 50B, 50C, 50D to be selected based on its actual measured effects. Such ability to control the cooling system 100 can allow it to operate in a more energy efficient manner with cooling power being focused in areas where it is most needed and cooling power reduced in areas where further cooling is not required.

The contribution factors can be used to control the operation of the various cooling supplies 50A, 50B, 50C, 50D in the cooling system 100 to try and improve the efficiency of the cooling system 100. The contribution factors can be used to determine which cooling supplies 50A, 50B, 50C, 50D have lower overall contributions such that the power to drive them can be reduced. For example, the cooling supplies 50A, 50B, 50C, 50D can each be set to provide a selected level of cooling that corresponds with their contribution, as determined by the foregoing. The first cooling supply 50A may be driven to provide a cooling power of only 20% of its maximum power output, if it was determined that its contribution to the room 10 cooling is only 20% of the total room 10. Additionally, hot spots (i.e. areas where one or more devices in the room 10 generate more heat than other devices in other parts of the room 10) can be more efficiently addressed by increasing the contribution to the cooling of the room 10 by the controlling the cooling supplies 50A, 50B, 50C, 50D that have a greater effect on the portion of the room 10 where the hot spot is located.

By providing the temperature sensors 16 in a permanent-type installation and possibly operably in communication with the central computer 1, they are available for regular monitoring of the room 10 air conditioning. For example, the temperature sensors 16 can be monitored periodically to cause the cooling supplies 50A, 50B, 50C, 50D to be adjusted to accommodate changes in the room 10. After the air conditioning system 100 is set up to drive the cooling supplies 50A, 50B, 50C, 50D, temperature sensors 16 may be monitored to determine if the selected cooling supplies 50A, 50B, 50C, 50D are cooling the room 10 adequately, such as providing too little or too much cooling at different locations in the room 10.

Such a system may also be useful to respond to temporary changes in temperature in the room 10 by automatically monitoring the temperature sensors 16 and feeding back a control to the air conditioning system 100 to adjust the volume and/or temperature of flow through one or more of the cooling supplies 50A, 50B, 50C, 50D to bring the room 10 into an acceptable temperature range. This may for example be useful when some devices in the room 10 are being run at greater than normal levels, when one or more devices or their cooling systems are failing or when an air conditioning unit is failing.

With contribution factors obtained for the cooling system 100, such as by using the method 300 illustrated in FIG. 5 or passively monitoring the room 10 over time and determining the contribution factors, the cooling system 100 can then be configured to automatically react to measured temperature changes by one of the temperature sensors 16. FIG. 7 is a flowchart illustrating a method 400 for altering the output of the cooling system 100 in response to one or more of the temperature sensors 16 measuring a temperature beyond a threshold level.

Method 400 begins at step 405 with one or more of the temperature sensors 16 measuring a temperature deviation beyond a temperature threshold. The temperature deviation is typically a temperature measurement that is greater than the desired temperature range. However, in some cases, the temperature deviation may indicate that a temperature sensor 16 is measuring a temperature that is cooler than a desired temperature range which could indicate that devices in the room 10 are being overcooled and that the cooling system 100 is expending unnecessary energy providing unnecessary cooling.

With at least one of the temperature sensors 16 measuring a temperature deviation, the central computer 1 can then obtain the contribution factors associated with the one or more temperature sensor 16 measuring the temperature deviation at step 410.

With the contribution factors indicating how much each of the cooling supplies 50A, 50B, 50C, 50D affect the air in the room 10 surrounding the temperature sensors 16 that are measuring the temperature deviation, the contribution factors can be used to select one or more of the cooling supplies 50A, 50B, 50C, 50D at step 415.

In one aspect, the contribution factors for a temperature sensor 16 measuring a temperature deviation could be analyzed and the cooling supply 50A, 50B, 50C, 50D that contributes the most to the temperature of the air where the temperature sensor 16 is located could be selected. In a further aspect, if more than one temperature sensor 16 measures a deviation beyond the temperature threshold, the differential between the measured temperature of each temperature sensor 16 over the threshold temperature could be used with the contribution factors to select one or more of the cooling supplies 50A, 50B, 50C, 50D. In this manner, the temperature sensors 16 reading the greatest temperature change can be weighted by having the contribution factors associated with those temperature sensors 16 taken into more account than the contribution factors of those temperature sensors 16 measuring a smaller temperature deviation from the temperature threshold.

Using the one or more cooling supplies 50A, 50B, 50C, 50D selected at step 415, the selected one or more cooling supplies 50A, 50B, 50C, 50D could be adjusted at step 420. The selected one or more cooling supplies 50A, 50B, 50C, 50D could be adjusted by turning it on or the amount of cool air provided by the cooling supply 50A, 50B, 50C, 50D could be increased to reduce the temperature in the room 10 at the location where the temperature sensors 16 are reading the temperature deviation.

In this manner, the central computer 1 can use the contribution factors to determine which cooling supplies 50A, 50B, 50C, 50D will have the greatest effect on the temperature of the room 10 at the locations of the temperature sensors 16 measuring the elevated temperatures. By using the contribution factors, the central computer 1 can choose one or more of the cooling supplies 50A, 50B, 50C, 50D to cool the temperature of the air at the temperature sensors 16 recording the elevated temperature. In this manner, the central computer 1 can potentially reduce the amount of cooling required by selecting one or more of the cooling supplies 50A, 50B, 50C, 50D that will have the most effect on the portion of the room 10 that needs the cooling, instead of selecting one or more of the cooling supplies 50A, 50B, 50C, 50D that may be overdriven and expend unnecessary additional energy trying to decrease the temperature in a portion of the room 10 it has less effect on than one of the other cooling supplies 50A, 50B, 50C, 50D. Additionally, by running the configuration method 300 shown in FIG. 5, the central computer 1 does not have to have knowledge of where the temperature sensors 16 are located within the room 10 (although it could), but rather can use the determined contribution factors to determine the effects of the different cooling supplies 50A, 50B, 50C, 50D on the locations in the room where temperature sensors 16 are provided.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A method for determining the effect of a plurality of cooling supplies on temperatures in a room containing a plurality of computer devices and at least one temperature sensor, the method comprising;
running all of the cooling supplies to provide a first level of cooling and then obtaining a temperature measurement using the at least one temperature sensor;
for each cooling supply, altering the cooling provided by the cooling supply and after a selected period of time obtaining a temperature measurement using the at least one temperature sensor; and
using the temperature measurements to determine contribution factors, each contribution factor indicating the effect of one of the plurality of cooling supplies at the location of one of the plurality of temperature sensors.

2. The method of claim 1 wherein a plurality of temperature sensors are provided in the room and a contribution factor is determined for the effect of each cooling supply on each of the plurality of temperature sensors.

3. The method of claim 1 wherein the first level of cooling is a maximum output of each cooling supply.

4. The method of claim 1 wherein the cooling provided by each cooling supply is altered by reducing the cooling provided to the room by the cooling supply.

5. The method of claim 1 wherein the cooling provided by each cooling supply is altered by stopping the cooling supply from providing cooling to the room.

6. The method of claim 2 further comprising using the contribution factors to control the operation of the cooling supplies.

7. A cooling system for cooling a room containing a number of computer devices, the system comprising:
a plurality of temperature sensors installed in the room;
two or more cooling supplies, each cooling supply operative to provide cooling to at least a portion of the room; and
a central computer operative to receive temperature measurements measured by the plurality of temperature sensors.

8. The cooling system wherein the central computer is operative to:
after all of the cooling supplies have been operating at a first level, obtain temperature measurements from the plurality of temperature sensors;
after the operation of each of the cooling supplies has been altered to operate at a second level while the other cooling supplies continue to operate at the first level, obtain temperature measurements from the plurality of temperature sensors; and
using the temperature measurements, determine a plurality of contribution factors, each contribution factor associated with one of the temperature sensors and one of the cooling supplies and indicating the effect of the cooling supply on a temperature of air in the room at the location of the temperature sensor.

9. The cooling system of claim 8 further comprising an output device operative to control the operation of a plurality of cooling supplies and wherein the central computer controls the operation of the two or more cooling supplies using the contribution factors.

10. The cooling system of claim 7 wherein at least one of the plurality of temperature sensors is installed on a rack containing one or more computer devices.

11. The cooling system of claim 10 wherein the rack has a plurality of temperature sensors positioned on the rack.

12. The cooling system of claim 11 wherein two of the temperature sensors installed on the rack are associated as a pair with one of the temperature sensors in the pair provided on a first side of the rack and the other of the temperature sensors in the pair is provided on a second side of the rack.

13. The cooling system of claim 11 wherein the plurality of temperature sensors positioned on the rack are operably connected to a control system which is operably connected to the central computer such that a temperature measurement taken by one of the temperatures sensors positioned on the rack is communicated to the central computer by the control system.

14. The cooling system of claim 13 wherein the control system is operatively connected to at least one fan provided in the rack.

15. The cooling system of claim 13 wherein the control system is operably connected to a power supply in the rack.

16. The cooling system of claim 7 wherein at least one of the cooling supplies includes an air conditioning unit and at least one air inlet leading into the room, the air inlet operably connected to the air conditioning unit.

17. The cooling system of claim 7 wherein at least two of the cooling supplies share a single air conditioning unit.

18. A computer readable memory for access by an application program being executed on a data processing system, comprising:
a data structure stored in said memory, the data structure including information used by said application program and including:
a plurality of contribution factors, each contribution factor associated with a temperature sensor located in a room and a cooling supply operable to provide cooling to the room, the contribution factor indicating the effect of the associated cooling supply on the temperature in the room where the associated temperature sensor is located.

19. The computer readable memory of claim 18 wherein the data structure further includes an indication of a rack provided in the room that a temperature sensor associated with at least one of the contribution factors is installed on.

20. A computer for controlling the operation of a cooling system for cooling a room containing a plurality of devices, the computer comprising:
an input device operative to receive temperature measurements from a plurality of temperature sensors;
an output device operative to control the operation of a plurality of cooling supplies, each cooling supply operative to provide cooling to at least a portion of the room;
at least one memory containing program instructions and a plurality of contribution factors, each contribution factor associated with one of the cooling supplies and one of the temperature sensors, the contribution factor indicating how the associated cooling supply effects the temperature in the room at the location of the associated temperature sensor;
at least one processing unit operably connected to the input device, the output device and the at least one memory, the at least one processing unit, in response to the program instructions, operative to:
in response to receiving a temperature measurement outside a temperature threshold, from at least one of the temperature sensors,
obtain the contribution factors associated with the at least one temperature sensor providing the temperature measurement outside the temperature threshold;
select at least one of the cooling supplies based on the obtained contributions factors; and
control the operation of the at least one selected cooling supply to bring the temperatures to within the temperature thresholds.

21. The computer of claim 20 wherein the contribution factors are determined by:
operating all of the cooling supplies at a first level and then measuring temperatures in the room using the temperature sensors;
for each cooling supply, altering the operation of the cooling supply and after a selected period of time measuring temperatures in the room using the temperature sensors;
after each cooling supply has been altered and the temperatures in the room measured, using the temperature differentials measured for each temperature sensor to determine the contribution factors.
